(19) United States
(12) Patent Application Publication
(10) Pub. No.: US 2014/0231186 A1
(43) Pub. Date: Aug. 21, 2014

(54) Mechanism for adjusting a distance between wheel rim and brake pad

(71) Applicant: Da Hao Wu, Changhua (TW)

(72) Inventor: Da Hao Wu, Changhua (TW)

(21) Appl. No.: 14/264,057

(22) Filed: Apr. 29, 2014

(51) Int. Cl. B62L 1/14; F16D 65/46

(52) U.S. Cl. CPC B62L 1/14; F16D 65/46
USPC 188/24.19

(57) ABSTRACT

A brake mechanism of a bicycle brake is provided with two brake arms each including a bifurcated main body having two opposite, longitudinal through slot members, an insert having a longitudinal through slot and disposed in the main body, and a fastening member driven through the through slot members and the through slot to adjustably fasten the insert and the main body together; and two brake pads each threadedly secured to the insert. A movement of each fastening member along the through slot members and the through slot transversely moves one brake pad, thereby adjusting a distance between a wheel rim and one adjacent brake pad.

### BACKGROUND OF THE INVENTION

1. Field of the Invention

The invention relates to bicycle brakes and more particularly to a mechanism for adjusting a distance between a wheel rim and a brake pad.

2. Description of Related Art

There is a conventional bicycle brake pad holder is provided with a hollow fastening rod comprising a head, a concave surface on the head, and an annular flange on the concave surface; a brake pad mount including a slotted channel, a convex receptor opposite the channel, a hole through the convex receptor, and a nut disposed in the hole, the nut having a projection projecting out of the hole; a brake pad removably mounted on the channel; and a bolt driven into the fastening rod to secure to the nut with the receptor urged against the concave surface and the flange put on the projection. A loosening of the bolt disengages the receptor from the concave surface to allow the receptor to move vertically and transversely relative to the flange. Hence, an adjustment of a distance between the brake pad and a wheel rim is effected.

However, the adjustment has limited applications. Thus, the need for improvement still exists.

### SUMMARY OF THE INVENTION

It is therefore one object of the invention to provide a brake mechanism of a bicycle brake comprising two brake arms each including a bifurcated main body having two opposite, longitudinal through slot members, an insert having a longitudinal through slot and disposed in the main body, and a fastening member driven through the through slot members and the through slot to adjustably fasten the insert and the main body together; and two brake pads each threadedly secured to the insert; wherein a movement of each of the fastening members along the through slot members and the through slot transversely moves one of the brake pads, thereby adjusting a distance between a wheel rim and one of the brake pads adjacent thereto.

The above and other objects, features and advantages of the invention will become apparent from the following detailed description taken with the accompanying drawings.

### BRIEF DESCRIPTION OF THE DRAWINGS

FIG. 1 is an exploded view of a linear-pull brake according to the invention;

FIG. 2 is a perspective view of the assembled linear-pull brake;

FIG. 3 is a front view showing a first wheel disposed between the brake pads in a first position; and

FIG. 4 is a front view showing a second wheel disposed between the brake pads in a second position by moving the fasteners upward along the through slots.

### DETAILED DESCRIPTION OF THE INVENTION

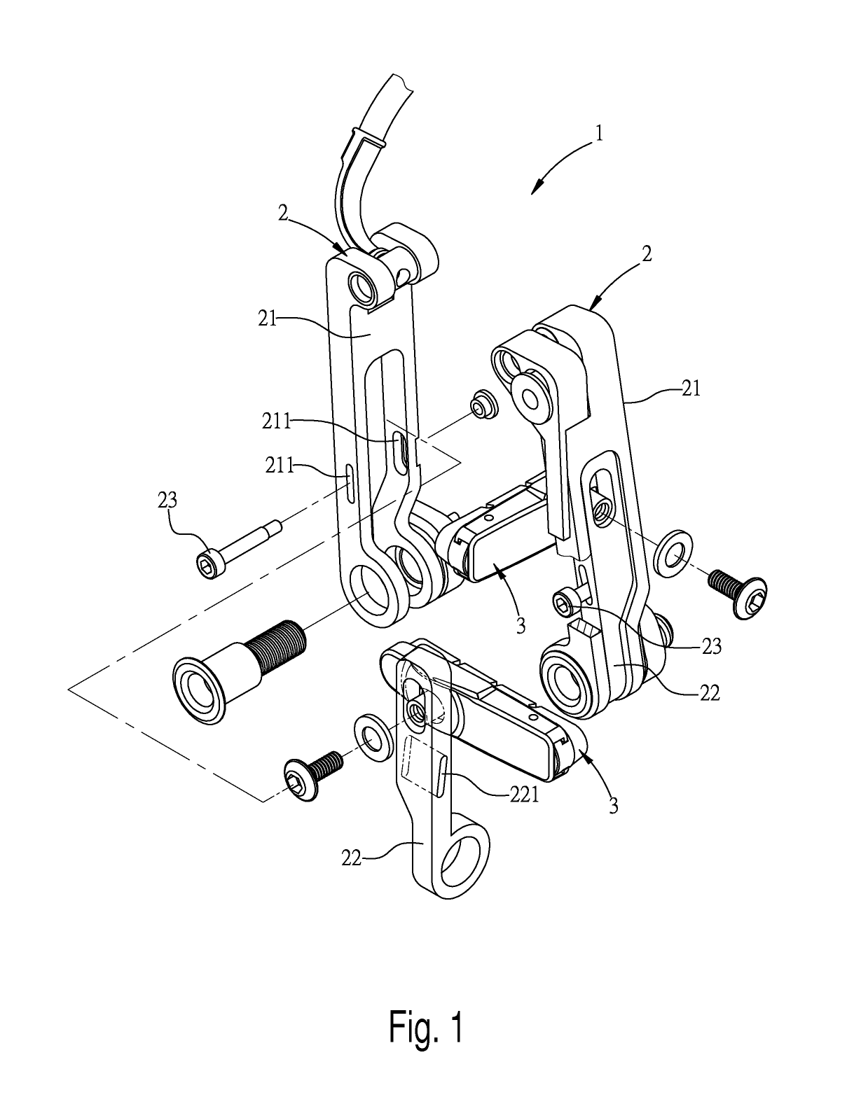

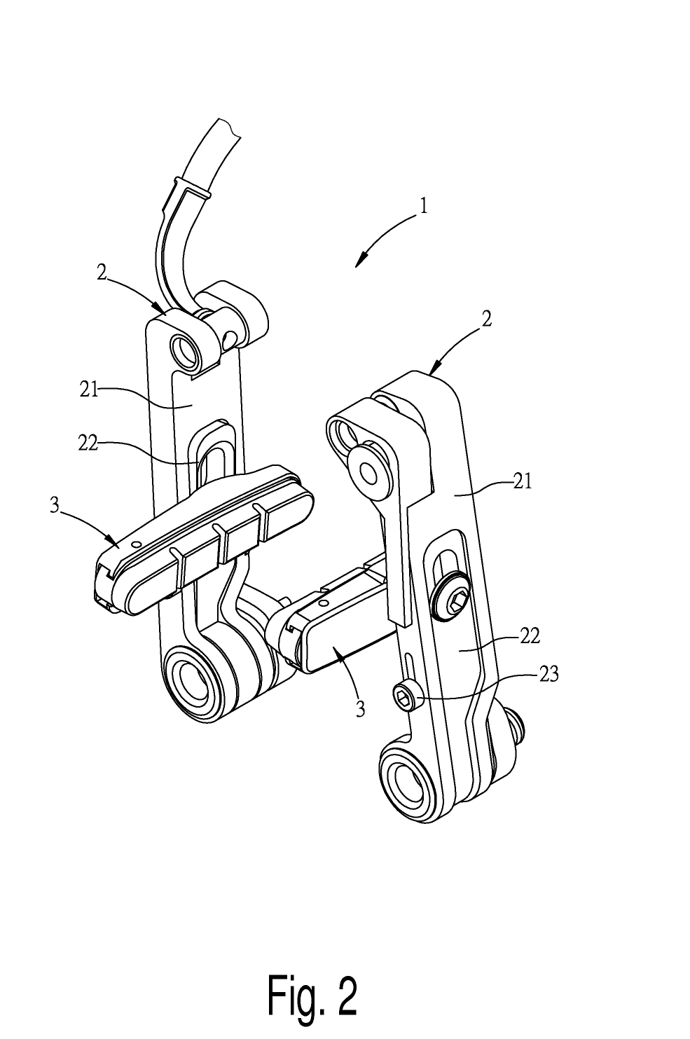

Referring to FIGS. 1 to 4, a linear-pull brake 1 of a bicycle in accordance with the invention comprises the following components as discussed in detail below.

Two brake arms 2 each include a bifurcated main body 21 secured to a frame (not shown) of the bicycle, the main body 21 having two opposite, longitudinal through slots 211, an insert 22 having a through slot 221 and disposed in the main body 21, and a fastener 23 driven through the slots 211 and the through slot 221 to adjustably fasten the insert 22 and the main body 21 together. Two brake pads 3 each are threadedly secured to the insert 22.

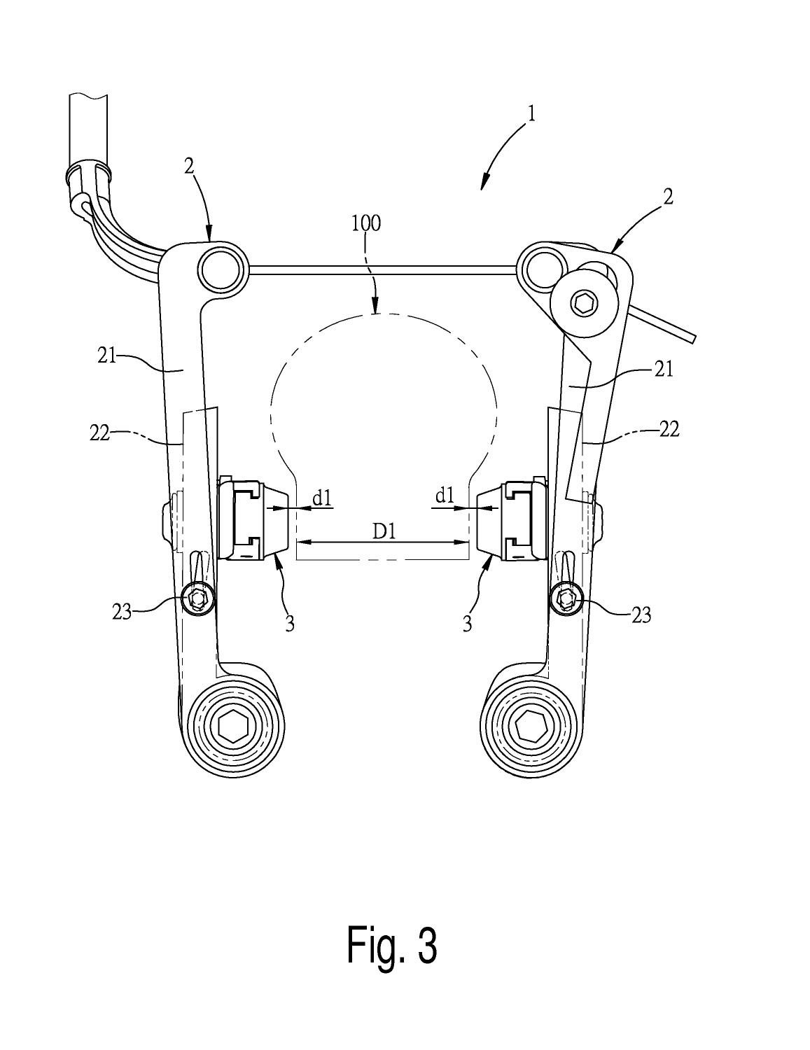

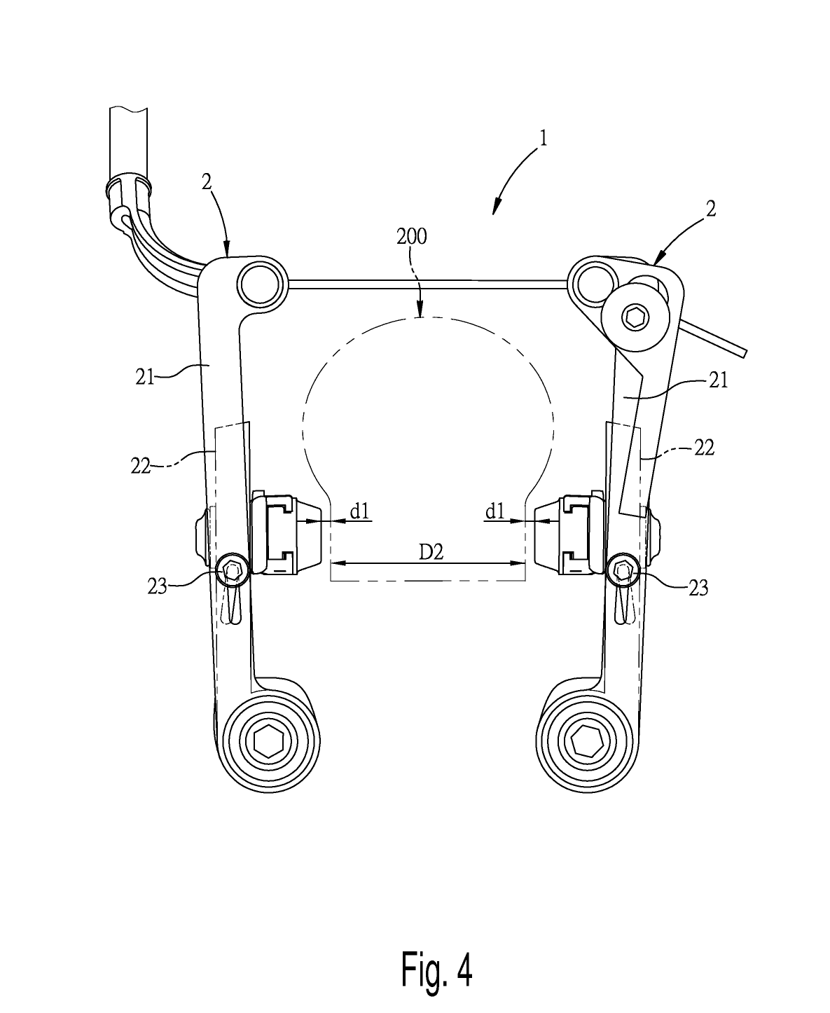

A distance between the brake pads 3 is sufficient to allow a wheel 100 having a rim with a width of D1 (see FIG. 3) or D2 (see FIG. 4). Value of D2 is greater than that of the D1.

Distance adjustment between the rim of the wheel 100 and either brake pad 3 is described in detail below. The distance between the rim of the wheel 100 and either brake pad 3 is represented by d1. It is understood that d1 may increase after a period time of use due to wear of the rubber pad of the brake pad 3. In response, a bicycle driver may move the fasteners 23 downward along the through slots 211, 221 from the position of FIG. 4 to the position of FIG. 3 to move an upper portion of the insert 22 (i.e., the brake pad 3) inward, i.e., the brake pad 3 moving transversely. As a result, the distance d1 is decreased and the purpose of adjusting the distance between the rim of the wheel 100 and either brake pad 3 is achieved.

While the invention has been described in terms of preferred embodiments, those skilled in the art will recognize that the invention can be practiced with modifications within the spirit and scope of the appended claims.

What is claimed is:

1. A brake mechanism of a bicycle brake comprising:
two brake arms each including a bifurcated main body having two opposite, longitudinal through slot members, an insert having a longitudinal through slot and disposed in the main body, and a fastening member driven through the through slot members and the through slot to adjustably fasten the insert and the main body together; and
two brake pads each threadedly secured to the insert;
wherein a movement of each of the fastening members along the through slot members and the through slot transversely moves one of the brake pads, thereby adjusting a distance between a wheel rim and one of the brake pads adjacent thereto.
